(19) United States
(12) Patent Application Publication
(10) Pub. No.: US 2006/0081803 A1
(43) Pub. Date: Apr. 20, 2006

(54) Electromagnetically actuatable valve, in particular for braking force systems in motor vehicles

(76) Inventors: Dieter Kawa, Erdmannhausen (DE); Harald Speer, Freiberg (DE); Klaus Heyer, Freiberg (DE); Florian Richter, Hemmingen (DE); Dietmar Kratzer, Tamm (DE); Bernd Kellner, Waltenhofen (DE); Elmar Vier, Freiberg A.N. (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/249,381

(22) Filed: Oct. 14, 2005

(30) Foreign Application Priority Data
Oct. 15, 2004 (DE) 10 2004 050 221.8

(51) Int. Cl. F16K 31/02

(52) U.S. Cl. 251/129.15

(57) ABSTRACT

An electromagnetically actuatable valve for braking force systems in motor vehicles, has a valve housing, with tappet element axially displaceable in the housing cooperating with a valve body and forming a sealing seat at a sealing face. The valve housing has a plurality of radially extending pressure medium outlet bores which are covered by a filter element. The disposition and embodiment of the outlet bores results in a flow course for the pressure medium that reduces the flow resistance of the valve and thus improves the valve properties.

### BACKGROUND OF THE INVENTION

1. Field Of The Invention

The invention relates to an electromagnetically actuatable valve, in particular for braking force systems in motor vehicles.

2. Description of the Prior Art

One valve of the type with which this invention is concerned is already known and has a valve body that is press-fitted into a valve housing. Between the valve body and the valve housing, preferably a plurality of longitudinal grooves extend in the longitudinal direction of the valve; these grooves discharge into radially outward-projecting outlet bores that are covered by a filter element embracing the outlet bores. When the valve closing member has lifted from the valve seat, a pressure medium flows through the valve or the valve body, initially essentially in the longitudinal axis of the valve, and after passing through the seat is first deflected 180° in order to reach the aforementioned longitudinal grooves. Next, the pressure medium is deflected a further 90°, so that after passing through the outlet bores and the filter element, it can leave the valve. Because of the multiple deflection motions of the pressure medium, relatively high flow resistances arise, which adversely affect the function and valve properties of the valve.

### OBJECT AND SUMMARY OF THE INVENTION

The electromagnetically actuatable valve of the invention, in particular for braking force systems in motor vehicles, has the advantage over the prior art that its valve properties are improved, and its throttling losses are reduced. This is achieved essentially by providing that a pressure medium, after passing through the sealing seat at the valve body, has to be deflected out of its flow direction only once, by 90°, in order to reach the outlet bores.

Advantageous refinements of the valve of the invention are disclosed. It is especially advantageous if the valve housing has a reduced-diameter portion on its outer circumference, in the region of the outlet bores, that is surrounded by the filter element. This makes it possible for the pressure medium, after flowing through the outlet bores, to be distributed over a larger region of the filter element, which especially with high pressure medium viscosities of the kind that occur at low temperatures, leads to reduced flow resistance and hence to improved valve properties. To make a secure, pressure-tight connection between the filter element and the valve housing possible, it is also provided in a preferred embodiment that the filter element is equipped with a mounting rib which engages an encompassing annular groove embodied on the valve housing and which can be pressed with this annular groove in the axial direction.

### BRIEF DESCRIPTION OF THE DRAWINGS

The invention will be better understood and further objects and advantages thereof will become more apparent from the ensuing detailed description of a preferred embodiment, taken in conjunction with the drawings, in which:

FIG. 1 is a longitudinal section through an electromagnetically actuatable valve of the invention; and

FIG. 2 is a section in the plane II-II of FIG. 1.

### DESCRIPTION OF THE PREFERRED EMBODIMENT

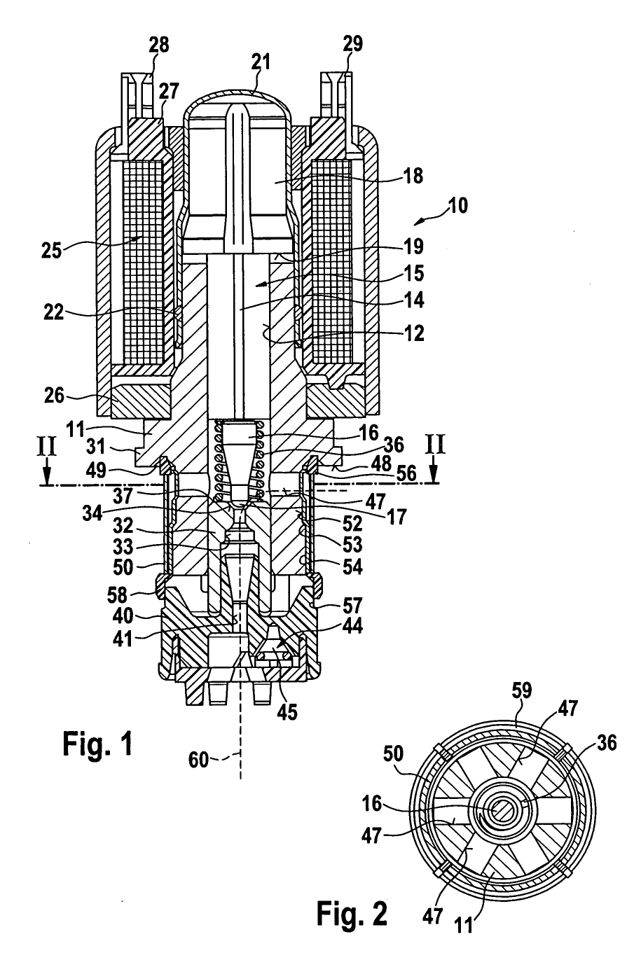

The electromagnetically actuatable valve 10 shown in FIG. 1 is used particularly in braking force systems in motor vehicles, such as anti-lock brake systems or ESP (electronic stability program) systems. It has a valve housing 11, in the middle of which a through bore 12 is embodied. A tappet element 15 which has four longitudinal ribs 14 is guided longitudinally displaceably with little radial play in the through bore 12 and, on one face end, has an extension 16 with a valve closing element 17 of substantially hemispherical shape.

On the end of the tappet element 15 diametrically opposite the extension 16, the tappet element 15 cooperates with an armature 18, which contacts one face end 19 of the tappet element 15. The armature 18 is surrounded, with slight radial play, by a capsule 21, in which the armature 18 is axially displaceable by a small distance. The capsule 21 is joined in fluid-tight fashion with the valve housing 11 circumferentially by means of a welded connection 22.

A region of the armature 18 and partly also a region of the tappet element 15 are surrounded by a coil element 25 that can be supplied with electric current. The coil element 25 has a flux guide element 26 and a coil body 27; the electrical terminals 28 and 29 of the coil body serve to supply current to the coil element 25.

Below the coil element 25 and the flux guide element 26, the valve housing 11 has an encompassing mounting flange 31. The mounting flange 31 is located approximately at the level of the extension 16 of the tappet element 15. On the end of the tappet element 15 toward the extension 16, a valve body 32 is press-fitted into the through bore 12. In the exemplary embodiment, the valve body 32 has a graduated, multiply stepped bore 33. On the side toward the extension 16, the stepped bore 33 is conically widened and, together with the valve closing element 17, forms a sealing seat at a conical face 34. The extension 16 of the tappet element 15 is surrounded by a compression spring 36, which is braced between the face ends 37, facing one another, of the valve body 32 and the ribs 14 of the tappet element 15 and presses the tappet element 15, with its valve closing element 17, away from the sealing seat or from the conical jacket face 34.

On the side facing away from the tappet element 15, a preferably plastic valve closing connecting element 40 is press-fitted into the stepped bore 33 of the valve body 32. The valve connection element 40 has a through bore 41 that communicates with the stepped bore 33 of the valve body 32. The through bore 41 communicates with an inlet conduit, not shown. The valve connection element 40 also has an integrated check valve 44 with a conical valve body 45.

At least nearly at the same height as the face end 37 of the valve body 32, a plurality of transverse or outlet bores 47 (FIG. 2), in this exemplary embodiment six of them, are offset from one another by 60° each. The outlet bores 47 located in the region of the extension 16 of the tappet element 15 extend as far as a height just below the end face 48 of the mounting flange 31. An annular groove 49 embodied in the end face 48 of the mounting flange 31, serves to secure a filter element 50, which covers the outlet bores 47. On its outer circumference, in the region of the outlet bores 47, the valve housing 11 also has a portion 52 of reduced diameter that also extends a certain distance in the direction of the valve connection element 40. The portion 52 is adjoined, via a chamfer 53, by a further portion 54, which is adapted in diameter to the inside diameter of the filter element 50 and extends up to the valve connection element 40. The filter element 50, on each of its face ends, has a respective annularly encompassing securing rib 56 and 58, preferably made of plastic. One securing rib 56, associated with the annular groove 49, protrudes into the annular groove 49 of the mounting flange 31 and is wedged to it in the axial direction. The other securing rib 58, toward the valve connection element 40, radially surrounds the valve closing element 40 at a securing portion 57. The filter element 50 thus covers both portions 52 and 54 of the valve housing 11, and the portion 54 serves to centrally guide and brace the filter element 50 on the valve housing 11. An annularly encompassing space 59 is embodied between the filter element 50 and the reduced diameter portion 52.

The valve 10 described thus far can be inserted into a valve block, not identified by reference numeral; the mounting flange 31 serves to secure the valve 10 to the valve block. Inflow and outflow conduits that communicate with the inflow conduit via bore 41 and the outlet bores 47, respectively, are embodied in the valve block.

When there is no current to the valve 10, the compression spring 36 lifts the tappet element 15 and the valve closing element 17 away from the sealing seat at the edge 34. Depending on the current supplied to the coil element 25, a closing force counter to the force of the compression spring 36 is generated on the tappet element 15 via the armature 18 and presses the tappet element 15 together with the valve closing element 17 in the direction of the conical jacket face 34 of the valve body 32. By way of the current supplied to the coil element 25, the flow through the valve 10 can thus be varied. In the state shown in FIG. 1, the coil element 25 is not being supplied with current; that is, the valve is open. The flow course 60 of the pressure medium, represented by dashed lines in FIG. 1, therefore extends through the inflow conduit and the through bore 41 via the edge 34 in the direction of one of the outlet bores 47. It can be seen that after passing the edge 34, the pressure medium is deflected only once relative to the longitudinal axis of the valve by approximately 90° out of its original flow direction into the direction of the outlet bore 47. It can also be seen that after passing the outlet bore 47, the pressure medium can become distributed over the entire portion 52 of the valve housing 11, since in this region the space 59 is embodied, formed by the spacing between the valve housing II and the filter element 50. This enlarged space 59 is wanted, particularly at low temperatures with high-viscosity pressure medium, since it reduces the flow resistance of the pressure medium at the filter element 50 and makes use of a larger surface area of the filter element 50 for the pressure medium to pass through.

The valve 10 of the invention can be modified in various ways without departing from the concept of the invention. In particular, it is possible and conceivable to provide a different number of outlet bores 47, which need not be uniformly located relative to one another and may have different diameters, or may be attached at different angles from the 90° angle to the longitudinal axis shown in the flow course 60.

The foregoing relates to a preferred exemplary embodiment of the invention, it being understood that other variants and embodiments thereof are possible within the spirit and scope of the invention, the latter being defined by the appended claims.

We claim:

1. In an electromagnetically actuatable valve for braking force systems in motor vehicles, the valve having a valve housing in which a valve body with an admission bore for a pressure medium is located, the admission bore cooperating at a sealing face with a tappet element that is actuatable by an armature for forming a sealing seat, and the tappet element being coupled with a compression spring whose spring force acts counter to the magnetic force of the armature; and having at least one radially disposed outlet bore for the pressure medium, which bore is embodied in the valve housing, the at least one outlet bore cooperating with a filter element located on the outer circumference of the valve housing, the improvement wherein the at least one outlet bore, on the side toward the tappet element, is located in the region of the tappet element, so that the pressure medium, along its flow course, after flowing through the valve body and passing the sealing face, is deflected only once relative to the longitudinal axis of the valve for entry into the at least one outlet bore.

2. The valve in accordance with claim 1, wherein the valve body is press-fitted into a longitudinal bore of the valve housing; and wherein the at least one outlet bore in the valve housing adjoins the admission bore at the level of the face end, toward the tappet element, of the valve body.

3. The valve in accordance with claim 1, wherein the valve housing, in the region of the at least one outlet bore, has a portion of reduced outer diameter which extends past the region of the at least one outlet bore; and wherein this reduced diameter portion is covered by the filter element, and an annular open space is formed between the portion and the filter element.

4. The valve in accordance with claim 2, wherein the valve housing, in the region of the at least one outlet bore, has a portion of reduced outer diameter which extends past the region of the at least one outlet bore; and wherein this reduced diameter portion is covered by the filter element, and an annular open space is formed between the portion and the filter element.

5. The valve in accordance with claim 1, wherein the valve housing has a mounting flange, which on the side toward the tappet element extends above the at least one outlet bore; wherein the mounting flange, on an end face toward the filter element, has an encompassing annular groove; and that the filter element has an encompassing mounting rib, which can be connected to the annular groove.

6. The valve in accordance with claim 2, wherein the valve housing has a mounting flange, which on the side toward the tappet element extends above the at least one outlet bore; wherein the mounting flange, on an end face toward the filter element, has an encompassing annular groove; and that the filter element has an encompassing mounting rib, which can be connected to the annular groove.

7. The valve in accordance with claim 3, wherein the valve housing has a mounting flange, which on the side toward the tappet element extends above the at least one outlet bore; wherein the mounting flange, on an end face toward the filter element, has an encompassing annular groove; and that the filter element has an encompassing mounting rib, which can be connected to the annular groove.

8. The valve in accordance with claim 4, wherein the valve housing has a mounting flange, which on the side toward the tappet element extends above the at least one outlet bore; wherein the mounting flange, on an end face toward the filter element, has an encompassing annular groove; and that the filter element has an encompassing mounting rib, which can be connected to the annular groove.

9. The valve in accordance with claim 3, wherein the portion on the valve housing of reduced outer diameter is adjoined, on the side facing away from the at least one outlet bore, by a portion, which for guiding and bracing the filter element has an enlarged diameter, adapted to the inside diameter of the filter element in that region.

10. The valve in accordance with claim 4, wherein the portion on the valve housing of reduced outer diameter is adjoined, on the side facing away from the at least one outlet bore, by a portion, which for guiding and bracing the filter element has an enlarged diameter, adapted to the inside diameter of the filter element in that region.

11. The valve in accordance with claim 5, wherein the portion on the valve housing of reduced outer diameter is adjoined, on the side facing away from the at least one outlet bore, by a portion, which for guiding and bracing the filter element has an enlarged diameter, adapted to the inside diameter of the filter element in that region.

12. The valve in accordance with claim 6, wherein the portion on the valve housing of reduced outer diameter is adjoined, on the side facing away from the at least one outlet bore, by a portion, which for guiding and bracing the filter element has an enlarged diameter, adapted to the inside diameter of the filter element in that region.

13. The valve in accordance with claim 7, wherein the portion on the valve housing of reduced outer diameter is adjoined, on the side facing away from the at least one outlet bore, by a portion, which for guiding and bracing the filter element has an enlarged diameter, adapted to the inside diameter of the filter element in that region.

14. The valve in accordance with claim 1, wherein a plurality of outlet bores are disposed at substantially equal angular spacings from one another.

15. The valve in accordance with claim 2, wherein a plurality of outlet bores are disposed at substantially equal angular spacings from one another.

16. The valve in accordance with claim 3, wherein a plurality of outlet bores are disposed at substantially equal angular spacings from one another.

17. The valve in accordance with claim 4, wherein a plurality of outlet bores are disposed at substantially equal angular spacings from one another.

18. The valve in accordance with claim 5, wherein a plurality of outlet bores are disposed at substantially equal angular spacings from one another.

19. The valve in accordance with claim 9, wherein a plurality of outlet bores are disposed at substantially equal angular spacings from one another.

20. The valve in accordance with claim 11, wherein a plurality of outlet bores are disposed at substantially equal angular spacings from one another.
